(19) United States
(12) Patent Application Publication
(10) Pub. No.: US 2014/0341795 A1
(43) Pub. Date: Nov. 20, 2014

(54) Fluorspar/Iodide Process for Reduction, Purification, and Crystallization of Silicon

(71) Applicant: Matthew J. Channon, Albuquerque, NM (US)

(72) Inventor: Matthew J. Channon, Albuquerque, NM (US)

(73) Assignee: Silichem LLC, Albuquerque, NM (US)

(21) Appl. No.: 14/450,333

(22) Filed: Aug. 4, 2014

Related U.S. Application Data
(63) Continuation-in-part of application No. 12/924,667, filed on Oct. 2, 2010.

(51) Int. Cl. C01B 33/029; C01B 7/14; C01B 33/10

(52) U.S. Cl. CPC C01B 33/029; C01B 33/10; C01B 7/14
USPC 423/341; 423/349; 423/500; 423/462

(57) ABSTRACT

Method and apparatus for producing molten purified crystalline silicon from low-grade siliceous fluorspar ore, sulfur trioxide gas, and a metallic iodide salt. Method involves: (1) initially reacting silicon dioxide-bearing fluorspar ore and sulfur trioxide gas in sulfuric acid to create silicon tetrafluoride gas and fluorogypsum; (2) reacting the product gas with a heated iodide salt to form a fluoride salt and silicon tetraiodide; (3) isolating silicon tetraiodide from impurities and purifying it by washing steps and distillation in a series of distillation columns; (4) heating the silicon tetraiodide to its decomposition temperature in a silicon crystal casting machine, producing pure molten silicon metal ready for crystallization; and pure iodine gas, extracted as liquid in a cold-wall chamber. The system is batch process-based, with continuous elements. The system operates largely at atmospheric pressure, requiring limited inert gas purges during batch changes.

### FIELD OF THE INVENTION

The present invention pertains generally to producing silicon feedstock for the aluminum, chemical, and semiconductor industries. The present invention pertains specifically to reaction of crude fluorspar, sulfuric gases, and iodide salts to produce pure silicon feedstock for use in fabricating photovoltaic and other semiconductor devices, and producing impure silicon metal, gypsum, fluoride salts, and pure iodine.

### BACKGROUND OF THE INVENTION

Over three-quarters of the photovoltaic modules sold annually are made from silicon. Manufacturers have repeatedly expressed concern about the future supply of low-cost silicon feedstock as this market continues to grow at a rate exceeding 30% each year. As photovoltaics continue to grow in popularity, the amount of silicon consumed by photovoltaics has exceeded the amount consumed by other semiconductor applications, and if current trends continue, will become the leading use of silicon, exceeding the supply capabilities not only of the silicon purification industry, but those of the far larger silicon metal reduction industry.

Although photovoltaic modules themselves produce no pollution, the current state of the art process to make silicon for photovoltaic modules, carbothermic reduction, utilizes coke or other cheap carbon sources to remove the oxygen from quartzite sand, requiring energy-intensive process temperatures up to 2000° C. and producing significant quantities of greenhouse gases, primarily carbon monoxide.

The current state of the art process of pure silicon crystal manufacture is complex and convoluted, involving raw material extraction at one site, carbothermic reduction at another, purification at another, crystallization at another, and PV cell and module fabrication at yet another. During every step except extraction, the silicon is heated to very high processing temperatures, and the heat is wasted in order to transport the material to the next site, where it must be heated again. During later steps, additional measures must be taken to avoid contamination or damage during transport.

Although multiple avenues exist for the purification of silicon, none have been commercially marketed that do not begin with metallurgical-grade silicon or carbothermic reduction in one form or another. Although quartzite sand is the preferred mineral source of silicon dioxide for existing processes, since it contains the fewest impurities, nearly every mineral deposit on Earth contains significant quantities of impure silicon dioxide.

Silicon in a useful form can not be derived from any natural source without removing the oxygen atoms it is bonded to. Although this is conventionally accomplished by the introduction of carbon and heat and removal of the oxide through a gas phase, as described by Kuhlmann (U.S. Pat. No. 3,215,522), other chemical processes can achieve removal of the oxygen atoms, most notably reaction with acidic fluorides. Acidic fluorides, most notably hydrofluoric acid, have been in use for decades to remove oxide layers from silicon wafers in the manufacture of semiconductor devices. Hydrofluoric acid is conventionally produced from a reaction between sulfuric acid and calcium fluoride ore, also known as fluorspar. Meyerhofer (GB-222,836) and Harshaw (U.S. Pat. No. 1,665,588) first patented this process. Most fluorspar deposits contain significant fractions of silicon dioxide (known as gangue), and ore processing is required in order to reduce the percentage of silicon dioxide in the final product If silicon dioxide is retained in the fluorspar, the reaction with sulfuric acid produces the typically undesirable intermediate product fluosilicic acid.

If fluosilicic acid, which only occurs in aqueous form, is dried, silicon tetrafluoride gas is evolved, Molstad (U.S. Pat. No. 2,833,628) produced a method to dry fluosilicic acid with concentrated sulfuric acid. Silicon tetrafluoride gas provides an alternate set of paths to achieve a reduced silicon metal product without the need for carbon. Because of this synergistic relationship between fluorides and silicon dioxide, impure fluorspar poses a superior alternative to quartzite sand as a naturally occurring source of silicon.

Metallurgical-grade silicon is a poor choice as a starting material for further refinement, since its metallic nature requires high processing temperatures and/or at least two chemical reactions (one to a gaseous form and one back to metal) in order for cost-effective purification to take place. This is routinely achieved in existing processes by reacting the metallurgical grade silicon with acid to form gaseous chlorosilanes and then reducing the chlorosilanes back to silicon metal. By starting with a material form that is easy to purify, and making the conversion to reduced silicon metal only once, one can achieve significant time, plant, and energy savings.

Silicon tetraiodide is an easily-purified form of silicon, melting at 120° C. and boiling at 287° C. Silicon tetraiodide also decomposes into silicon and iodine at elevated temperatures, without the need for other reactants, making it an excellent source material in situations where the purity of the end product is paramount.

Silicon tetrafluoride is easily converted to silicon tetraiodide through a double-replacement reaction with an iodide salt, though this is a novel method for making silicon tetraiodide. Moates (U.S. Pat. No. 3,006,737) was the first patent to mention using silicon tetraiodide as a means of purification of silicon, but never mentioned a specific starting material. Herrick (U.S. Pat. No. 3,020,129) used metallurgical-grade silicon as a source material for silicon tetraiodide, even though this requires the extra steps of creating metallurgical-grade silicon, and converting metallurgical-grade silicon into a gas. Wang (U.S. Pat. Nos. 6,468,886 and 6,712,908) and Fallavollita (CA 2,661,036) likewise used metallurgical-grade or other impure silicon metal as a starting point to manufacture silicon tetraiodide.

At the end of state of the art silicon purification processes, whether they rely on chlorosilanes or silicon tetraiodide, amorphous solid silicon is produced, typically in the form of chunks. These amorphous silicon chunks must be remelted in order to crystallize them and form them into a shape suitable for manufacture of semiconductor devices. Sylvania (GB-787,043), Moates, Ling (U.S. Pat. No. 3,012,861), Herrick, Lord (U.S. Pat. No. 5,810,934), Wang, and Fallavollita never addressed the possibility of combining the tetraiodide thermal decomposition process with further heating in order to achieve a pure liquid silicon product suitable for crystallization and eliminate the need for amorphous chunks.

Whereupon the silicon has reached its melting point, it must be cooled in a slow and tightly-controlled fashion to make crystalline silicon. Competing processes to achieve this include heat-exchanger-method (HEM) bulk crystallization, Czochralski (CZ)-based crystal pulling, float zone (FZ)-based crystal pulling, edge-defined film growth (EFG), and string ribbon growth. Each crystal growth technology requires a charge of pure molten silicon, and typically includes an energy-intensive melting and vacuum purge stage to bring the cool silicon chunk source material up to temperature in a contamination-controlled fashion.

### SUMMARY OF THE INVENTION

The utility of the present invention is to significantly reduce the manufacturing cost of photovoltaic solar cells and other devices, by significantly improving the process for making high-purity silicon metal.

An object of the present invention is to convert sulfur oxides and crude fluorspar into silicon tetrafluoride gas and gypsum.

An object of the present invention is to convert silicon tetrafluoride gas and metal iodide salt into silicon tetraiodide and fluoride salt.

An object of the present invention is to purify silicon tetraiodide and, in the same step, thermally decompose the purified silicon tetraiodide and melt the resulting silicon, making it directly suitable for crystallization without intermediate steps.

To achieve the previous and following objects and in accordance with the purpose of the present invention, as embodied and broadly described herein, the method of this invention may comprise producing pure silicon crystal by first placing solid low-grade fluorspar ore in a vat, filling the vat with sulfuric acid, aiding the continuous nature of the process by bubbling sulfur trioxide (SO₃) gas into the acid mixture, which first react to form aqueous fluosilicic acid (H₂SiF₆), and insoluble crude calcium sulfate (CaSO₄), also known as fluorogypsum or simply fluorgyp; then the sulfuric acid solution, recharged by the sulfur trioxide gas, strips the water from the fluosilicic acid, producing silicon tetrafluoride gas (SiF₄), which flows to the next stage. The crude silicon tetrafluoride reaches a heated chamber containing a charge of iodide salt, typically sodium iodide or potassium iodide, and undergoes a double-replacement reaction, producing a stable fluoride salt, typically sodium fluoride or potassium fluoride, and crude silicon tetraiodide (SiI₄) gas product. Next, the silicon tetraiodide undergoes numerous batch-based condensation, solidification, and melting stages, with washing agents such as n-heptane, to remove soluble impurities and purify the gas. Following this stage, the washed silicon tetraiodide gas enters a distillation column, separating the pure silicon tetraiodide gas from unwanted impurity gases such as boron triiodide (BI₃) and phosphorous triiodide (PI₃). After a desired purity of silicon tetraiodide is reached, it flows into a crystallization chamber heated to a temperature where it dissociates into silicon diiodide (SiI₂) gas and iodine (I₂) gas. The now-pure iodine gas is condensed in a cold trap to form liquid iodine product. The absence of iodine gas pressure further decomposes the silicon diiodide into molten silicon and additional iodine gas. This pressure drop also drives the aforementioned distillation process forward. As more and more silicon tetraiodide is flowed into the chamber, eventually a critical mass of liquid silicon is obtained. The gate valve to the crystallization chamber is closed, halting the flow of material, and the silicon crystallization stage begins.

Another object of the present invention is to provide a high tonnage process for producing lower grade silicon metal and gypsum from silicon-bearing fluorspar ore.

Another object of the present invention is to provide a method for producing silicon metal without consuming carbon fuels or producing carbon-bearing waste gases.

Additional objects, advantages and novel features of the invention shall be set forth in part in the description that follows, and in part will become apparent to those skilled in the art upon examination of the following or may be learned by the practice of the invention. The objects and the advantages of the invention may be realized and attained by means of the instrumentalities and in combinations particularly pointed out in the appended claims.

To produce silicon crystal using the method described herein, the apparatus of this invention may comprise a plurality of interconnected chambers that are at about atmospheric pressure.

### BRIEF DESCRIPTION OF THE DRAWINGS

The accompanying drawings, which are incorporated herein and form part of the specification, illustrate preferred embodiments of the present invention, and together with the description, serve to explain the principles of the invention.

FIG. 1 is a schematic diagram of the apparatus illustrating the flow of crude fluorspar and sulfuric acid for the production of crude silicon tetrafluoride gas.

FIG. 2 is a schematic diagram of the apparatus illustrating the flow of crude silicon tetrafluoride gas and metal iodide salts for the production of crude silicon tetraiodide liquid.

FIG. 3 is a schematic diagram of the apparatus illustrating the purification of silicon tetraiodide gas, as well as the decomposition and crystallization of the purified silicon component and the capture and recovery of the purified iodine component.

FIGS. 4 & 5 are summary diagrams detailing the cycles, processes, and chemical reactions involved with the different stages of the method. In FIG. 5, the term “6N+” refers to the purity of the compound, meaning 99.9999+% pure, and “LP” refers to low purity. “c-Si” refers to solid Silicon in a crystallized form.

### DETAILED DESCRIPTION OF THE PREFERRED EMBODIMENTS

The invention provides methods and apparatus for generating one or more ultrapure silicon products containing tailored levels of impurities. Variable grades of silicon, iodine, metal fluoride salts, and gypsum can be produced at very high throughputs and very low cost with the process and apparatus disclosed herein. The best mode of this invention is to enable the high-throughput, low-cost and zero-carbon manufacture of high-purity crystalline silicon for use in photovoltaic cells.

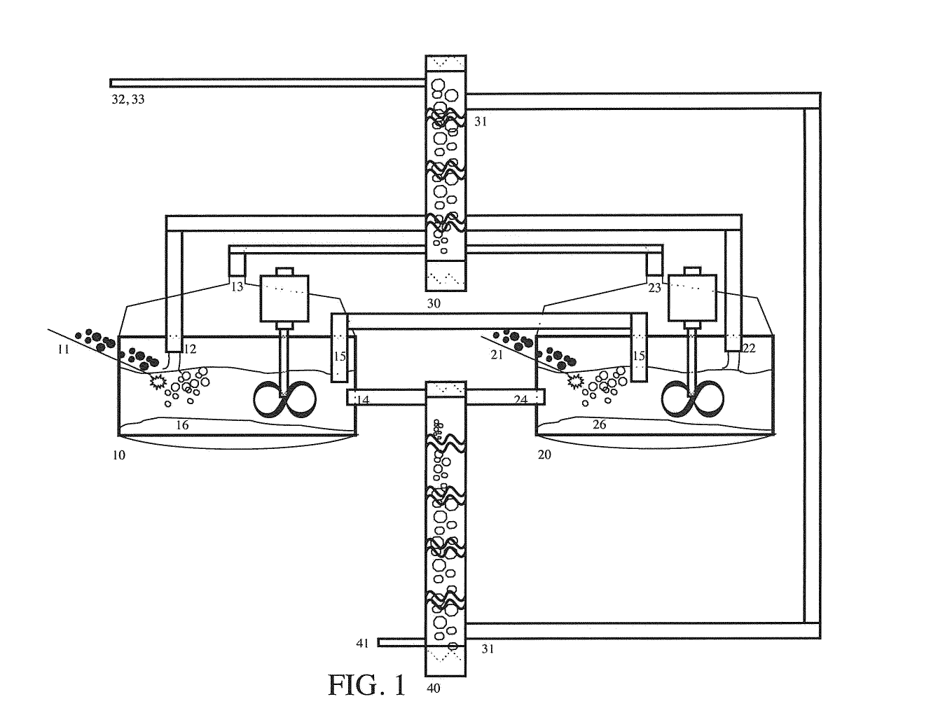

FIG. 1 shows the following: crushed fluorspar ore is introduced through conduit 11 into the first mixing tank 10 in Unit I. A sulfuric acid stream 12 flows from the second stage mixing column 30. The resulting reaction creates an insoluble gypsum product 16 which collects at the bottom of mixing tank 10, a reaction gas stream 13, composed primarily of silicon tetrafluoride, which flows into mixing column 30, suspended particles of silicon dioxide, hydrofluoric acid, and fluosilicic acid, which are pumped collectively as stream 14 into bubbler 40.

At such time as mixing tank 10 has accumulated sufficient gypsum product, conduits 11-14 are closed, and the remaining liquid contents of mixing tank 10 are pumped to mixing tank 20 through conduit 15. When the liquid has been sufficiently transferred, crushed fluorspar ore is again introduced through conduit 21 into mixing tank 20, sulfuric acid stream 22 flows from mixing column 30 into mixing tank 20, and reaction gas stream 23 composed of silicon tetrafluorides flows into mixing column 30, and remaining liquor pumped as before as stream 24 into bubbler 40.

When mixing tank 20 is active, mixing tank 10 is dumped and the solid contents 16 are removed. When mixing tank 20 has accumulated sufficient gypsum product, the liquid contents of mixing tank 20 are pumped back to tank 10 through conduit 15 as before, and when mixing tank 10 is active again, nixing tank 20 is dumped in the same fashion.

Mixing column 30 contains a concentrated sulfuric acid stream 31 at the top, providing a gradient of concentrated acid. As the liquid proceeds downward, any moisture in the gas proceeding upward is stripped out and absorbed by the acid, reducing the acid's concentration. Furthermore, as moisture is removed, the undesirable intermediate fluosilicic acid decomposes to hydrofluoric acid and silicon tetrafluoride gas. Dried silicon tetrafluoride gas streams 32 and 33 are transported to reactor 50 in Unit 2. Product liquid flows through stream 12 or stream 22 back to the mixing tanks.

Bubbler 40 receives a stream 41 of sulfur trioxide gas to convert the water in the liquor streams 14 and 24 to sulfuric acid, bringing the concentration of the solution closer to 98%. Stream 31 to mixing column 30 contains the concentrated sulfuric acid.

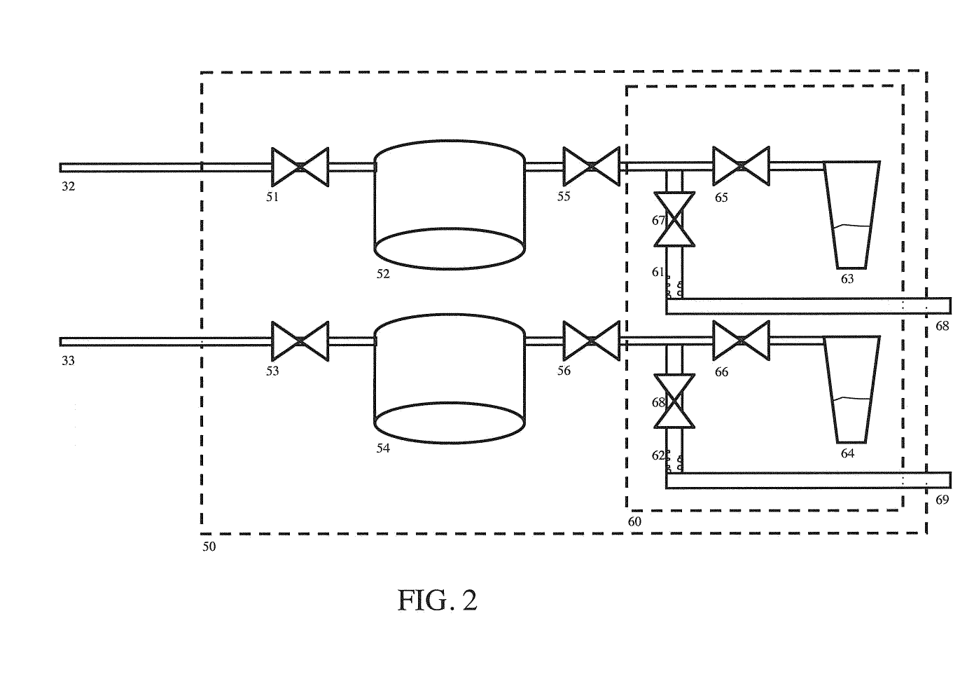

FIG. 2 shows the following: dried silicon tetrafluoride gas streams 32 and 33 reach reactor 50, which maintains a temperature of 200° C. Gate valve 51 links reactor 50's inlet 32 to ballast bottle 52, which has a capacity sufficient to store multiple liters of silicon tetrafluoride gas. As gas pressure in ballast bottle 52 reaches a point of 1.0 atm, gate valve 51 is closed and gate valve 53 linking reactor 50's inlet 33 opens, collecting silicon tetrafluoride gas in ballast bottle 54. After ballast bottle 54 reaches 1.0 atm, gate valve 53 is closed and the newly-emptied ballast bottle 52's gate valve 51 is opened, repeating the process.

When gate valve 51 is closed, gate valve 55 separating ballast bottle 52 from reaction chamber 60 is opened. Reaction chamber 60, which is maintained at 200° C., comprises water-cooled cold traps 61 and 62, maintained at 100° C., and reaction zones 63 and 64, maintained as gradients from 200° C. to 950° C. Gate valve 55 is teamed with gate valves 65 and 67 to permit the gas charge access to cold trap 61 and reaction zone 63 respectively. Gate valve 56 similarly separates ballast bottle 54 from reaction chamber 60, and is teamed with gate valves 66 and 68, to permit the gas charge access to cold trap 62 and reaction zone 64. The two sets of gate valves are actuated in a round-robin fashion to maintain a constant low-pressure demand for gas stream 32, and maintenance of temperatures in excess of 200° C. throughout reaction chamber 60 to prevent condensation of reaction products outside cold traps 61 and 62.

Reaction zones 63 and 64 both contain charges of metal iodide salts, heated to 950° C. to maintain molten salt. As heated silicon tetrafluoride gas reaches each reaction zone, a double replacement reaction takes place, resulting in formation of silicon tetraiodide gas and metal fluorides. Silicon tetraiodide gas moves throughout reaction chamber 60 and toward the open cold trap 61, where the 100° C. temperatures induce selective condensation of silicon tetraiodide liquid. The removal of the silicon tetraiodide gas maintains the silicon tetrafluoride/metal iodide reaction according to Le Chatelier's principle. As the molten salt is reacted, eventually a fluoride scale will form and the reaction rate will slow. At this point gate valve 65 is closed, and any remaining silicon tetraiodide vapor will condense on the cold trap 61, creating a partial vacuum.

During the time in which reaction zone 63 is open in reactor 60, reaction zone 64's salt charge is cooled, removed, replaced, gas purged, and heated. The mixed fluoride/iodide salt waste is separated using conventional aqueous procedures and combined with fresh supplies of metal iodide to yield a replacement reaction charge and byproduct metal fluorides. Similarly, during the time in which reaction zone 64 is open to reactor 60, reaction zone 63's salt charge is cooled, removed, replaced, gas purged, and heated.

During the time in which cold trap 61 is open to reactor 60, cold trap 62's silicon tetraiodide liquid is transferred via stream 68 to washing stage 70 in Unit 3. Similarly, during the time in which cold trap 62 is open to reactor 60, cold trap 61's silicon tetraiodide liquid is transferred via stream 69 to washing stage 70 in Unit 3.

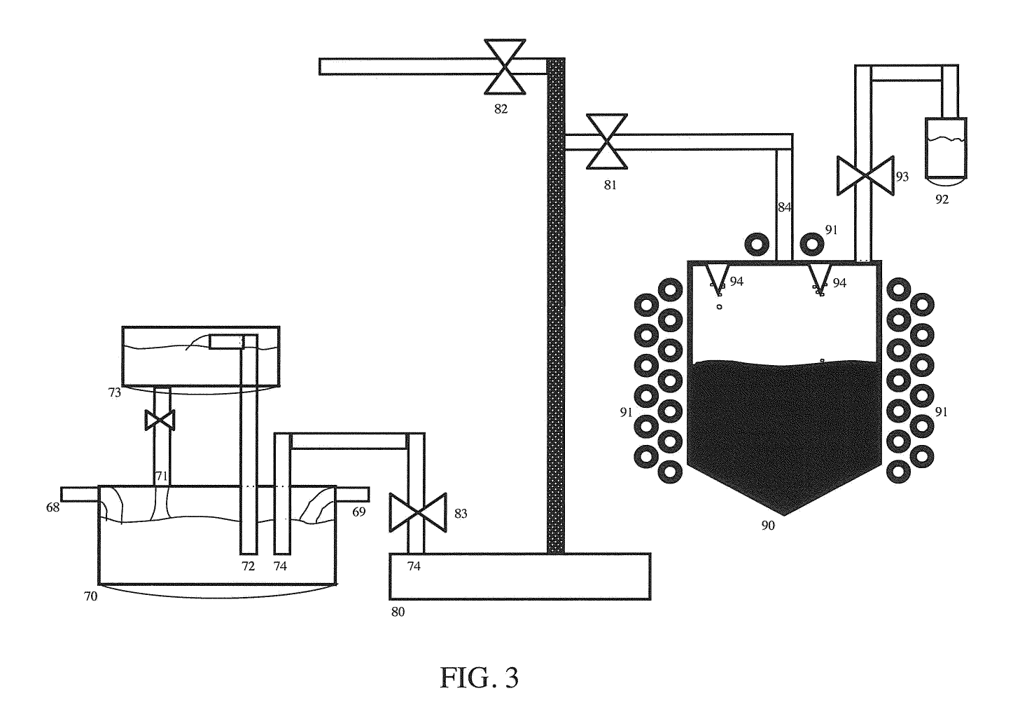

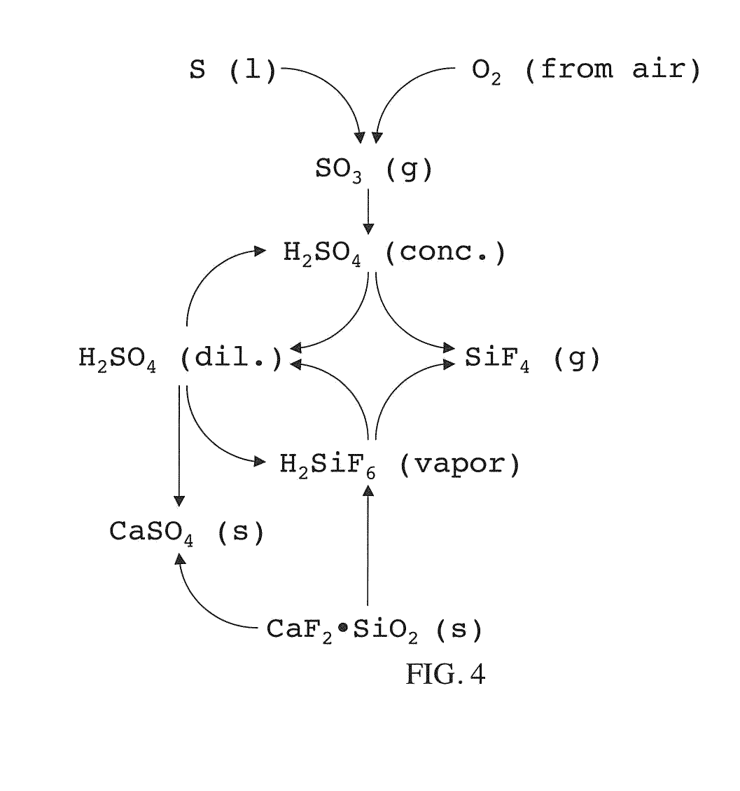

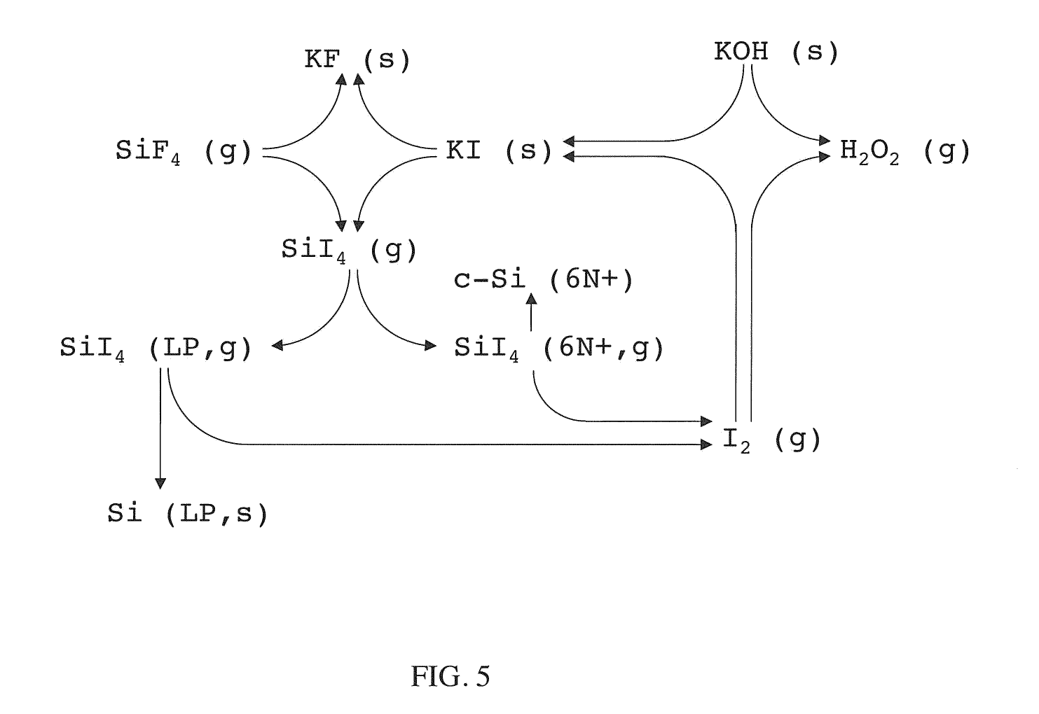

FIG. 3 shows the following: silicon tetraiodide liquid streams 68 and 69 reach washing stage 70 where the molten silicon tetraiodide is repeatedly mixed with a washing chemical 71, such as n-heptane, cooled to its fusion temperature, and n-heptane and impurities are together decanted from the washing step through pipe 72 to storage tank 73. The silicon tetraiodide is then remelted to undergo the procedure until the desired purity is reached.

After sufficient washing steps, the molten silicon tetraiodide reaches distillation column 80 through decanter pipe 74, where the bottom is heated to 315° C. and the top is cooled to 122° C. Lighter and heavier impurity fractions become separated. Gate valves 82 and 83 are closed to separate the impurities fractions, Gate valve 81 is opened to allow approximately 50% of the purified now—gaseous silicon tetraiodide to reach decomposer/crystallizer 90. After gate 81 is closed, gate valves 82 and 83 are re-opened to allow recycling of the impurity fractions along with the next charge of silicon tetraiodide from streams 68 and 69. Gate valves 82 and 83 may also allow injection of desired impurity vapors (particularly BI₃ or PI₃) to tailor the dopant characteristics of the silicon product.

Decomposer/crystallizer 90 is a commercially available silicon crystallization furnace, which is typically designed to melt a supply of polysilicon chunk and gas purge to reduce contamination, then cool the silicon supply to just above its melting point, where either a seeding-and-extraction process or slow-cooled casting process is to take place. Instead of supplying solid polysilicon chunks, the gaseous stream 84 is introduced to heating elements 91 which create a temperature of 1500° C., sufficient not only to decompose the silicon tetraiodide but to melt the silicon left over. To ensure complete participation by the silicon tetraiodide, cone-shaped cold sink features 94, which point downward and are maintained at 250° C., facilitate condensation of silicon tetraiodide, and dripping takes place into the melt, where thermal decomposition is all but guaranteed. As an equilibrium is reached and gas pressure reaches a constant level, gate valve 93 is opened and pure iodine is collected in a cold trap 92 held at 175° C. atop the machine, maintaining a forward bias to the iodide decomposition reaction

SiI₄ [symbol] SiI₂+I₂ [symbol] Si+2I₂

As the reaction is completed, a small supply of molten silicon has collected in the bottom of the furnace and a moderate supply of liquid iodine has collected in the cold trap. A gate valve 93 separates cold trap 92, where the contents are Gate valve 93 is reopened, and the process repeats until a sufficient charge of molten silicon has formed for a conventional crystallization process to take place. As iodine is expensive, a few kg of iodine may be recycled multiple times through the process before a single molten silicon charge is completed.

### DESCRIPTION OF THE CLAIMS

A description of the claims is included.

A method (hereby referred to as method 1) is proposed, of producing silicon tetrafluoride gas from the aqueous reaction of crude fluorspar and concentrated sulfuric acid, said method comprising the steps of:
(a) bubbling SO₃ gas into dilute H₂SO₄ to produce concentrated (greater than 70% by weight) sulfuric acid and
(b) combining milled fluorspar ore or fluorspar tailings with sulfuric acid to produce a liquor of dilute sulfuric acid and fluosilicic acid, and insoluble product CaSO₄ and
(c) combining the concentrated sulfuric acid from step (a) with the sulfuric/fluosilicic acid liquor from step (b) to generate silicon tetrafluoride gas and produce aforementioned dilute sulfuric acid in step (a).

A method according to method 1 is proposed where the milled fluorspar ore is composed of a stoichiometric ratio of approximately 72.2 wt % CaF₂ and the balance SiO₂.

A method according to method 1 is proposed where the milled fluorspar ore contains a non-stoichiometric ratio or other impurities with the purpose of generating byproduct gypsum and other product materials with additives to improve salability and quality.

A method according to method 1 is proposed where the milled fluorspar ore contains a percentage of glass originally obtained from consumers or industry for recycling.

A method of producing silicon tetraiodide gas from the gas-phase reaction of silicon tetrafluoride with a halogen salt (hereafter referred to as method 5) is proposed, said method comprising:
(d) Introducing SiF₄ gas into a container with heated Iodine-bearing salt and
(e) Using a cold trap to capture product SiI₄ from the mixed gas phase and
(f) Collecting the product salt for separation into fluoride-bearing byproduct and iodine-bearing salt for reuse

A method according to method 5 is proposed, where the container airtight, nonreactive to fluoride compounds, and heated at sufficient temperature to react the Iodine-bearing salt with the SiF₄ gas.

A method according to method 5 is proposed, where the Iodine-bearing salt is in the form of LiI, BeI₂, NaI, MgI₂, KI, CaI₂, RbI, SrI₂, or a combination thereof.

A method according to method 5 is proposed (hereafter referred to as method 8), where the cold trap is held beneath 200° C., at a temperature suitable to cause condensation of SiI₄, but not cause condensation of other intermediate compounds.

A method according to method 5 is proposed, where the container is designed such that the Iodine-bearing salt is heated and held in a nonreactive container within the larger container, such as a nickel crucible, to minimize risk of reaction with the larger container involving high temperatures.

A method according to method 5 is proposed, where the fluoride-bearing byproduct is recycled by reacting it with I₂ gas to produce iodine-bearing salts.

A method of producing in batches molten high purity silicon and high purity iodine gas from the purification and thermal decomposition of crude silicon tetraiodide gas from separate batch sources (hereafter referred to as method 11) is proposed, said method comprising:
(g) liquefaction of crude SiI₄ gas and
(h) repeated steps adding and removing nonreactive liquid washing chemicals such as alkane mixtures including hexanes, heptanes, and octanes, to separate impurities by boiling and freezing the crude SiI₄ material mixture into a less crude SiI₄ material (and more crude SiI₄ material to be used for method 13), and
(i) fractional distillation of the less crude SiI₄ material to produce pure SiI₄ material and impure SiI₄ material and
(j) introduction of the pure SiI₄ material to a heated crystallization furnace to produce molten Si metal and I₂ gas and
(k) collection of I₂ gas from this furnace in a cold trap and
(l) crystallization of the melt of sufficient size to produce semiconductor-grade ingots, sheets, or boules suitable for wafering and further processing.

A method according to method 11 is proposed where the crystallization furnace uses a Czochralski, Heat-Exchanger Method (HEM) casting, directional solidification casting, edge-defined film growth, or string ribbon method to grow crystalline material directly from a melt.

A method according to method 11 (hereafter referred to as method 13) is proposed where non-useful dopant iodides captured in method 8, comprising BI₃, AlI₃, PI₃, GaI₃, InI₃, AsI₃, are separated from the crude SiI₄ gas, as well as from each other, to be discarded, sold, or aggregated for use in a separate, differently doped crystal.

A method according to method 11 is proposed, where individual dopant iodides, previously part of the crude silicon tetraiodide but removed as described in method 13, are individually reintroduced to the pure silicon tetraiodide to produce silicon alloys with physical or electrical properties reflecting the characteristics these additives impart.

A method according to method 11 is proposed, where as-distilled pure SiI₄ material is first separated as in a centrifuge. By rotating the material at very high speeds, molecules containing lighter isotopes of Si are separated to produce isotopically pure SiI₄. These can then be processed according to method 11(i) to produce isotopically pure silicon and isotopically pure iodine. These isotopically pure materials hold special value in semiconductor and industrial applications, allowing for superior thermal conductivity over their unseparated counterparts.

A method according to method 11 is proposed, where the impure byproduct SiI₄is reused as the source to the distillation column.

A method according to method 11 is proposed, where the collected I₂ gas is cooled and sold.

A method according to method 11 is proposed, where the collected I₂ gas is recycled by reacting it with a metallic ore, oxide, hydroxide, carbonate, or halide to produce iodine-bearing salts.

A method according to method 11 is proposed, where the impure SiI₄ waste material from the distillation column (detailed in method 11(c)) is re-run through the remainder of the system (as described in method 11), thermally decomposed, and the remaining liquid (as described in method 11(d)) quickly cooled, to produce an impure Si metal.

A method according to method 11 is proposed, where the impure SiI₄ waste material from the distillation column (detailed in method 11(c)) is re-run through the remainder of the system (as described in method 11), thermally decomposed, and the remaining I₂ gas (as described in method 11(d)) is recycled by reacting it with a metallic ore, oxide, hydroxide, carbonate, or halide to produce iodine-bearing salts.

What is claimed is:

1. A method of producing silicon tetrafluoride gas from the aqueous reaction of crude fluorspar and concentrated sulfuric acid, said method comprising the steps of:
a. bubbling SO₃ gas into dilute H₂SO₄ to produce concentrated (greater than 70% by weight) sulfuric acid and
b. combining milled fluorspar ore or fluorspar tailings with sulfuric acid to produce a liquor of dilute sulfuric acid and fluosilicic acid, and insoluble product CaSO₄ and
c. combining the concentrated sulfuric acid from step (a) with the sulfuric/fluosilicic acid liquor from step (b) to generate silicon tetrafluoride gas and produce aforementioned dilute sulfuric acid in step (a).

2. A method according to claim 1 where the milled fluorspar ore is composed of a stoichiometric ratio of approximately 72.2 wt % CaF₂ and the balance SiO₂.

3. A method according to claim 1 where the milled fluorspar ore contains a non-stoichiometric ratio or other impurities with the purpose of generating byproduct gypsum and other product materials with additives to improve salability and quality.

4. A method according to claim 1 where the milled fluorspar ore contains a percentage of glass originally obtained from consumers or industry for recycling.

5. A method of producing silicon tetraiodide gas from the gas-phase reaction of silicon tetrafluoride with a halogen salt, said method comprising:
a. Introducing SiF₄ gas into a container with heated Iodine-bearing salt and
b. Using a cold trap to capture product SiI₄ from the mixed gas phase and
c. Collecting the product salt for separation into fluoride-bearing byproduct and iodine-bearing salt for reuse

6. A method according to claim 5 where the container is airtight, nonreactive to fluoride compounds, and heated at sufficient temperature to react the Iodine-bearing salt with the SiF₄ gas.

7. A method according to claim 5 where the Iodine-bearing salt is in the form of LiI, BeI₂, NaI, MgI₂, KI, CaI₂, RbI, SrI₂, or a combination thereof.

8. A method according to claim 5 where the cold trap is held beneath 200° C., at a temperature suitable to cause condensation of SiI₄, but not cause condensation of other intermediate compounds.

9. A method according to claim 5 where the container is designed such that the Iodine-bearing salt is heated and held in a nonreactive container within the larger container, such as a nickel crucible, to minimize risk of reaction with the larger container involving high temperatures.

10. A method according to claim 5, were the fluoride-bearing byproduct is recycled by reacting it with I₂ gas to produce iodine-bearing salts.

11. A method of producing in batches molten high purity silicon and high purity iodine gas from the purification and thermal decomposition of crude silicon tetraiodide gas from separate batch sources, said method comprising:
a. liquefaction of crude SiI₄ gas and
b. repeated steps adding and removing nonreactive liquid washing chemicals such as alkane mixtures including hexanes, heptanes, and octanes, to separate impurities by boiling and freezing the crude SiI₄ material mixture into a less crude SiI₄ material and more crude SiI₄ material and
c. fractional distillation of the less crude SiI₄ material to produce pure SiI₄ material and impure SiI₄ material and
d. introduction of the pure SiI₄ material to a heated crystallization furnace to produce molten Si metal and I₂ gas and
e. collection of I₂ gas from this furnace in a cold trap and
f. crystallization of the melt of sufficient size to produce semiconductor-grade ingots, sheets, or boules suitable for wafering and further processing.

12. A method according to claim 11 where the crystallization furnace uses a Czochralski, Heat-Exchanger Method (HEM) casting, directional solidification casting, edge-defined film growth, or string ribbon method to grow crystalline material directly from a melt.

13. A method according to claim 11 is proposed where non-useful dopant iodides captured in claim 8, comprising BI₃, AlI₃, PI₃, GaI₃, GeI₄, InI₃, AsI₃, are separated from the crude SiI₄ gas, as well as from each other, to be discarded, sold, or aggregated for use in a separate, differently doped crystal.

14. A method according to claim 11, where dopant iodides, previously part of the crude silicon tetraiodide but removed as described in claim 13, are reintroduced to the pure silicon tetraiodide to produce silicon alloys with physical or electrical properties reflecting the characteristics these additives impart.

15. A method according to claim 11, where as-distilled pure SiI₄ material is first separated as in a centrifuge, to produce isotopically pure SiI₄, then processed according to claim 11(c) to produce isotopically pure silicon and isotopically pure iodine as described in paragraph [0058] of the detailed description.

16. A method according to claim 11, where the impure byproduct SiI₄ is reused as the source to the distillation column.

17. A method according to claim 11, where the collected I₂gas is cooled and sold.

18. A method according to claim 11, where the collected I₂ gas is recycled by reacting it with a metallic ore, oxide, hydroxide, carbonate, or halide to produce iodine-bearing salts.

19. A method according to claim 11, where the impure SiI₄ waste material from the distillation column (detailed in claim 11(c)) is re-run through the remainder of the system (as described in claim 11), thermally decomposed, and the remaining liquid (as described in claim 11(d)) quickly cooled, to produce an impure Si metal.

20. A method according to claim 11, where the impure SiI₄ waste material from the distillation column (detailed in claim 11(c)) is re-run through the remainder of the system (as described in claim 11), thermally decomposed, and the remaining I₂ gas (as described in claim 11(d)) is recycled by reacting it with a metallic ore, oxide, hydroxide, carbonate, or halide to produce iodine-bearing salts.
